(19) United States
(12) Patent Application Publication
(10) Pub. No.: US 2006/0279406 A1
(43) Pub. Date: Dec. 14, 2006

(54) Synchronization and adaptive timing method for multiple RFID reader system

(76) Inventors: Robert Stewart, Boulder, CO (US); Ing. Gunther Neger, Salzburg (AT)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/449,455

(22) Filed: Jun. 7, 2006

Related U.S. Application Data
(60) Provisional application No. 60/688,597, filed on Jun. 7, 2005.

(51) Int. Cl. H04Q 5/22

(52) U.S. Cl. 340/10.1; 340/572.1; 340/825.2

(57) ABSTRACT

In a system comprising multiple electronic (radio frequency) identification interrogator devices, which are used to activate and to receive identification code information from one or more passive transponder devices, activation signals are synchronized and adaptively timed by a master interrogator. The master interrogator generates a synchronization signal containing frequency, phase, and cadence information, and uses this synchronization signal to generate its own activation signal. The master interrogator also conveys this synchronization signal to slave interrogators, where it is used to generate each slave's activation signal. Each slave interrogator conveys to the master interrogator its transponder detection status information, and the master interrogator modifies the synchronization signal's cadence in compliance with timing requirements of ISO Standard 11785. A universal interrogator architecture is employed, whereby each interrogator is configured by software to be either the master interrogator or a slave interrogator. Fail-safe operation of the system is possible by virtue of a slave interrogator's ability to reconfigure itself as the master interrogator in the event of loss of the primary master interrogator's synchronization signal.

### RELATED APPLICATION

This application claims priority of provisional application 60/688,597 filed Jun. 7, 2005.

### BACKGROUND OF THE INVENTION

1. Field of the Invention

This invention relates to radio frequency identification (RFID) systems that are compliant with International Standards Organization (ISO) Standard 11785, “Radio frequency identification of animals-Technical Concept” (1996).

2. Background

ISO Standard 11785 defines the technical principles for communications between interrogator devices and electronic passive identification transponders. These transponders contain identification information stored in binary form, which is conveyed to the interrogator when a transponder is suitably activated by the interrogator. A complete description of the technical details is provided in ISO Standard 11785, which is incorporated herein by reference.

Briefly, ISO Standard 11785 defines two types of transponder technologies, which are designated “full-duplex” (i.e., “FDX-B”) and “half-duplex” (i.e., “HDX”). An FDX-B transponder amplitude modulates the interrogator's activation signal with its binary identification code sequence. The interrogator detects this modulation and derives from it the FDX-B transponder's identification code. An HDX transponder uses the interrogator's activation signal to charge an internal capacitor, and uses this stored energy to self-activate a transmitter which emits a frequency shift keyed (FSK) signal representative of the transponder's identification code. The interrogator detects this FSK signal and derives from it the HDX transponder's identification code. In this manner, activation energy is transferred to a transponder from an interrogator, and identification code information is transferred to the interrogator from a transponder through magnetic field coupling.

An ISO compliant interrogator has the capability to activate and detect both FDX-B and HDX type transponders. To accomplish this, the interrogator transmits an activation signal, comprising a 134.2 kilohertz (kHz) sinusoid, which is modulated in a prescribed ON and OFF pattern. During the interval in which the 134.2 kHz signal is ON, the FDX-B transponder is activated and transmits its identification code signal cyclically for as long as the activation signal is present. Also during this ON interval, an HDX transponder charges its internal capacitor. During the interval in which the 134.2 kHz activation signal is OFF, the FDX-B transponder is dormant, and the HDX transponder transmits its identification code sequence a single time.

Adaptive Timing Requirements

Typically, a suitable activation signal for FDX-B and HDX transponder types could be ON for 70 milliseconds (msec) and OFF for 20 msec. ISO Standard 11785, however, defines an adaptive timing scheme, the purpose of which is to shorten the detection time of transponders, and consequently, to improve reading speed. Specifically, this adaptive timing scheme requires the following:
The interrogator activation signal default timing is 50 msec ON and 3 msec OFF
If, during the 3 msec OFF interval, an HDX transponder signal is detected by the interrogator, the interrogator must extend the OFF interval to 20 msec in order to completely capture the HDX transponder's identification code.
If, during the 50 msec ON interval, an FDX-B transponder signal is detected by the interrogator, the interrogator may extend the ON interval up to 100 msec in order to completely capture the FDX-B transponder's identification code.
Every tenth activation cycle is fixed at 50 msec ON/20 msec OFF, regardless of transponder detection status.

Thus, an interrogator may exhibit the following four activation signal ON/OFF intervals:
No transponder detected: 50 msec ON/3 msec OFF
HDX transponder detected: 50 msec ON/20 msec OFF
FDX-B transponder detected: 50 to 100 msec ON/3 msec OFF
FDX-B and HDX transponders detected: 50 to 100 msec ON/20 msec OFF
   Synchronization Requirements

When more than one interrogator is present within a vicinity, or when more than one interrogator is used to read a single transponder, synchronization of all interrogators' activation signals is required. Several interrogators may be located nearby one another in order to read different transponders at different stations, or two or more interrogators may be positioned at a single station with the intention of reading a single transponder with greater reliability and/or redundancy.

An FDX-B transponder uses the activation signal's frequency content to derive internal timing for its digital circuitry. When multiple interrogators are sufficiently physically separated such that an FDX-B transponder does not simultaneously fall within the activation fields of multiple interrogators, there is no need to synchronize the interrogators' activation signals. However, when multiple interrogators are used to read a single FDX-B transponder, the frequency and the phase of the 134.2 kHz activation signals must be identical in order for the FDX-B transponder to operate.

An HDX transponder transmits its identification code using frequency shift keying (FSK) modulation wherein binary data (1's and 0's) are represented by two different close-by frequencies. HDX transponders use 134.2 kHz and 124.2 kHz for this purpose. Since one of these FSK frequencies is also the frequency of the interrogator's activation signal, it is necessary that no activation signals be ON within the vicinity where an HDX transponder is transmitting its identification code sequence. Thus, all interrogators—whether stationed separately to read separate HDX transponders, or stationed together to read a single HDX transponder—must have synchronized ON/OFF cadences. Synchronizing frequency and phase of the interrogators' activation signals is not especially critical for HDX transponders, but doing so is not detrimental.

Thus, in order for an ISO compliant interrogator to work cooperatively and collaboratively in multiple interrogator installations with both FDX-B and HDX type transponders, it is necessary for the activation signals of all interrogators to be synchronized with respect to the frequency and phase of the 134.2 kHz activation signal, and to be synchronized with respect to the ON/OFF cadence as well.

### SUMMARY OF THE INVENTION

The present invention provides a system and method by which the adaptive timing requirements of ISO Standard 11785 and the synchronization requirements of multiple interrogators are integrated in an efficient and effective manner. The invention uses an architecture in which one interrogator is designated as a “master”. The master interrogator produces a synchronization signal containing frequency, phase, and cadence timing information. All other interrogators, which require synchronization, are designated as “slave” interrogators. All slaves receive the synchronization signal from the master and use it as their activation signal. Slave interrogators return status signals to the master, indicative of transponder detection status, and the master alters the adaptive timing of the synchronization signal accordingly. In this way, the timing of the entire system is adjusted to suit the requirements of all interrogators, and all interrogators emit activation signals that are frequency, phase, and cadence synchronized.

Fail-safe operation can be incorporated into the synchronized interrogator system by defining a hierarchy of master interrogators. In the event of failure of the primary designated master interrogator, the slave interrogators can sense the loss of the synchronization signal and a designated slave can automatically reconfigure itself to become the system master and to provide the synchronization signal to the remaining slave interrogators.

### BRIEF DESCRIPTION OF THE DRAWINGS

FIGS. 1(a)-1(d) illustrates the synchronization signal from which the activation signal of all interrogators is derived.

FIGS. 2(a)-2(c) illustrate the distribution of a synchronization signal to slave interrogators, and the adaptive timing control bus by which the synchronization signal timing is adjusted in response to the transponder detection status of any slave interrogator.

FIG. 3(a) illustrates the “universal” interrogator's synchronization and adaptive timing control interface.

FIG. 3(b) illustrates the universal interrogator's synchronization and adaptive timing control interface as configured for operation as a “master” interrogator.

FIG. 3(c) illustrates the universal interrogator's synchronization and adaptive timing control interface as configured for operation as a “slave” interrogator.

FIG. 4 illustrates the interconnection wiring of the RS485 interfaces among master and slave interrogators.

### DETAILED DESCRIPTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

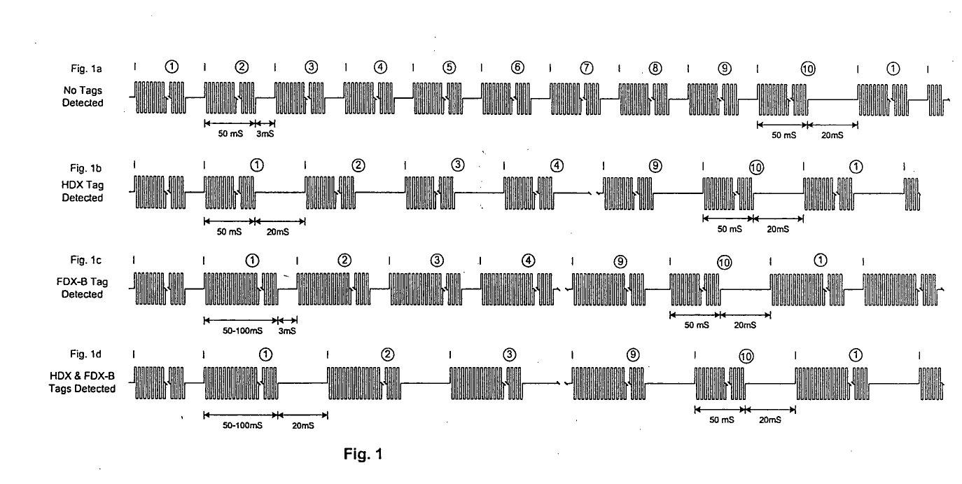

Referring to FIGS. 1(a)-1(d), an interrogator's activation signal consists of a 134.2 kHz frequency, which is switched on and off in accordance with certain timing intervals. FIG. 1(a) illustrates the timing for an interrogator that is not detecting any transponder at present. Accordingly, it assumes the timing pattern wherein its ON interval is 50 milliseconds (msec) and its OFF interval is 3 msec. This 50 msec/3 msec cadence occurs nine times in succession, followed by a tenth timing interval wherein the cadence adapts to 50 msec ON/20 msec OFF regardless of the detection status. If, for example, an FDX-B transponder is being detected, and nine consecutive interrogation cycles of 80 msec ON/3 msec OFF result, every tenth interval is 50 msec ON/20 msec OFF.

FIG. 1(b) illustrates the interrogator's activation signal when an HDX type transponder is detected. In this case, the timing adapts to 50 msec ON/20 msec OFF for nine consecutive intervals, followed by the tenth interval, which is also 50 msec ON/20 msec OFF.

FIG. 1(c) illustrates the interrogator's activation signal when an FDX-B type transponder is detected. When an FDX-B transponder is detected, the interrogator may adjust the activation signal's ON period up to as long as 100 msec in order to completely read the transponder. If the FDX-B transponder is successfully read within an interval less than 100 msec, the interrogator may terminate the ON interval at that time. Thus, when an FDX-B transponder is being read, the activation signal cadence consists of nine consecutive intervals wherein the ON period may vary cycle to cycle between 50 msec and 100 msec in duration, followed by the 3 msec OFF period. The tenth interval following these nine variable length intervals is fixed at 50 msec ON/20 msec OFF.

FIG. 1(d) illustrates the activation signal of an interrogator that is detecting an FDX-B and an HDX transponder concurrently. In his case, there are nine intervals consisting of variable ON periods of between 50 msec and 100 msec in duration and OFF periods of 20 msec. As is always the case, the tenth interval following these nine variable length intervals is fixed at 50 msec ON/20 msec OFF.

The signals illustrated in FIGS. 1(a)-1(d) depict an interrogator's activation signal, which is derived from a digital logic signal having similar characteristics. The digital logic signal typically comprises a unipolar (0 to 5 volt) square-wave shaped signal, while the activation signal is typically a bipolar high-voltage level sinusoid shaped signal, suitable for driving an antenna coil in order to produce a magnetic field. Despite these differences in voltage and wave shape, the activation signal and the digital logic signal have identical frequency, phase, and cadence (i.e., on/off interval timing) characteristics. The master interrogator's synchronization signal, which is distributed to the slave interrogators, is also derived from this same digital logic signal. Thus, the synchronization signal's frequency, phase, and cadence are accurately represented by FIGS. 1(a)-1(d) as well.

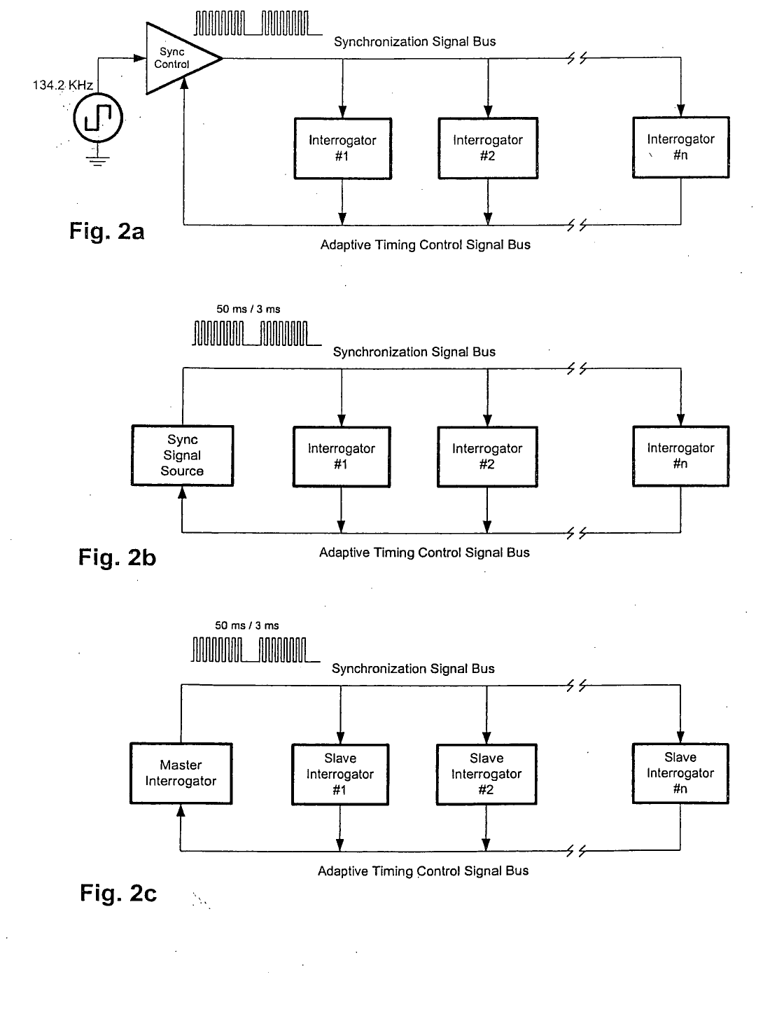

FIG. 2(a) illustrates the basic system architecture wherein the synchronization signal is generated and distributed to all interrogators from a common 134.2 kHz signal source through a synchronization control function. Each interrogator receives this synchronization signal, which is 50 msec ON/3 msec OFF when no transponder is being detected by any interrogator. Each interrogator outputs transponder detection status information onto the adaptive timing control signal bus. The adaptive control timing signal bus is input to the synchronization control function, and the timing of the synchronization signal is adjusted in accordance with the detection state of the interrogators. In this way, the timing of the entire system adjusts to the requirements of each and all of the interrogators.

FIG. 2(b) illustrates an installation of multiple interrogators that are synchronously timed from a single synchronization signal source, which is not an interrogator itself, but is instead a dedicated function. FIG. 2(c) illustrates an embodiment of the invention wherein the synchronization signal source is an interrogator that is configured as a “master”, and the synchronization signal is distributed to other interrogators that are configured as “slaves”. Slave interrogators return detection status signals to the master interrogator on the adaptive timing control bus, and the master adjusts the synchronization signal timing accordingly. When the master interrogator detects a transponder, it adjusts the synchronization signal without asserting a signal on the adaptive timing control bus.

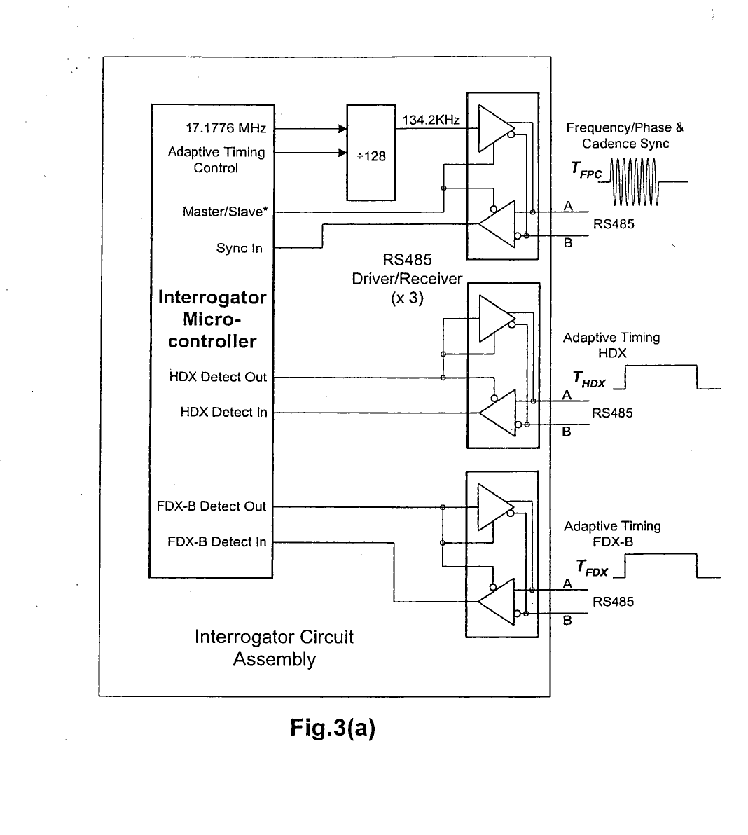

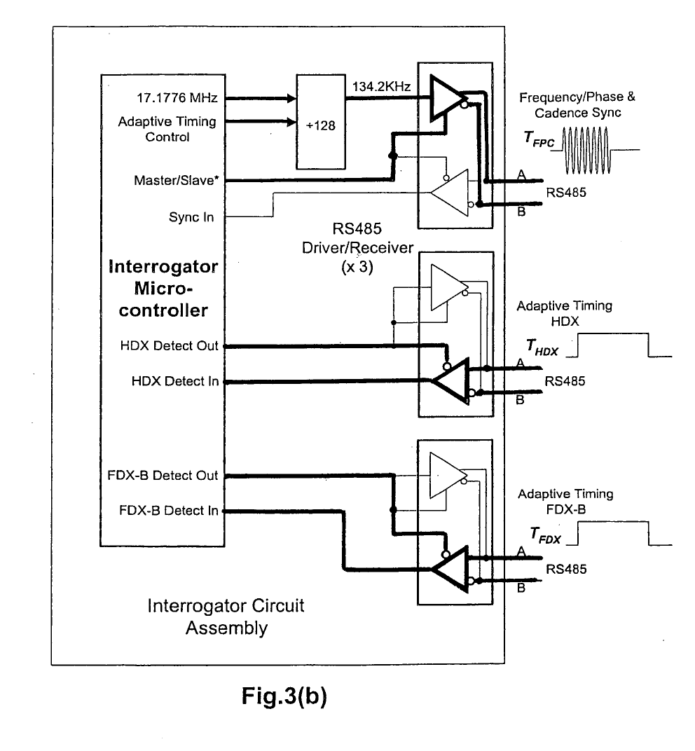

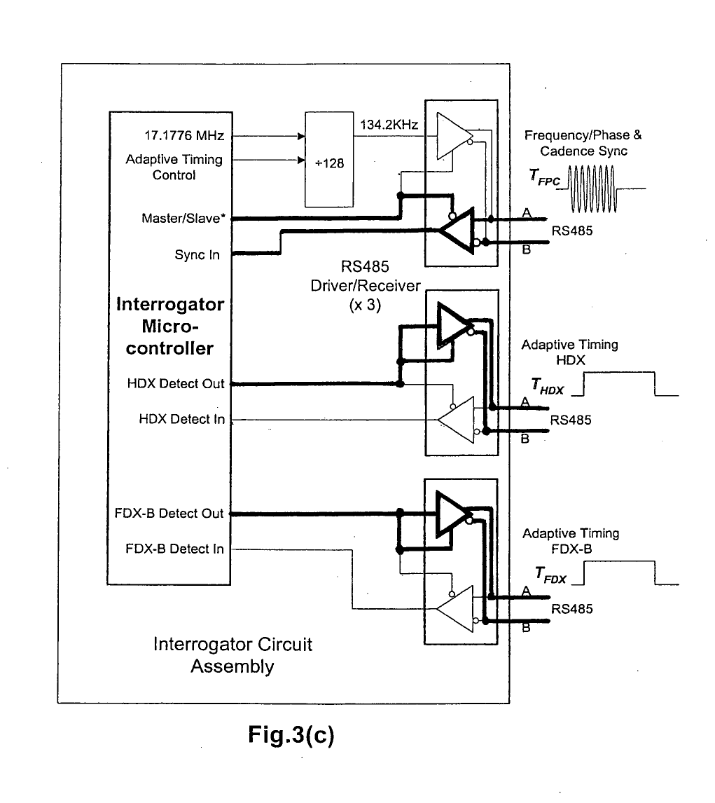

FIG. 3(a) illustrates a portion of a typical interrogator, which performs the functions of synchronization and adaptive timing in an embodiment of the invention. Typically, the interrogator includes a microcontroller device, which performs a variety of tasks pertinent to the interrogator's operation. Within the interrogator, a digital frequency source typically exists for the purpose of providing timing to the microcontroller. In the illustrated embodiment, this frequency source generates a 17.1776 megahertz (MHz) signal, which is divided digitally by 128 in order to derive the 134.2 kilohertz (kHz) activation signal and synchronization signal.

The synchronization signal and the transponder detection status signals may be communicated on an interrogator synchronization and adaptive timing interface comprising three two-wire circuits conforming to the TIA (Telecommunications Industry Association) RS485 electrical interface standard, “Electrical Characteristics of Generators and Receivers for Use in Balanced Digital Multipoint Systems”, which is incorporated herein by reference. Each of these electrical interfaces is typically a single integrated circuit device with 8 connection pins, such as the Texas Instruments SN75176B. Other integrated circuit devices containing multiple RS485 devices, such as the Texas Instruments SN751178 (which contains two RS485 interfaces) could be used. Furthermore, a wide selection of RS485 devices exists which feature a variety of parametric differences, all of which are equally usable in this application. Use of this industry standard interface provides several benefits and conveniences, including the capability to (a) easily synchronize interrogators of different manufacturers, (b) synchronize as many as 32 interrogators, (c) design a “universal” interrogator that can be field configured as either “master” or “slave” via software or simple hardware option settings, and (d) interconnect interrogators up to 100 meters apart using balanced 2-wire signal lines.

It will be understood that the interrogator synchronization and adaptive timing interface may be implemented in other ways. For example, instead of a RS485 bus, the synchronization signal and the transponder detection status signals may be communicated via an optical data interface, via a wireless radio frequency (RF) interface, or telephonically using modems.

FIG. 3(a) illustrates the universal synchronization and adaptive timing interface circuit. Each RS485 driver receiver consists of a signal transmitter and a signal receiver, and two enable/disable signals, which are connected together. The signal transmitter has a single wire input and a balanced 2-wire output, and converts a unipolar logic signal input to a bipolar signal output. The signal receiver has a balanced 2-wire input and a single wire output, and converts a bipolar signal input to a unipolar signal output. The enable/ disable input is driven by a 2-state logic signal, wherein the first logic state enables the transmitter portion and disables the receiver portion, while the second logic state disables the transmitter portion and enables the receiver portion. For the SN75176B device, the signal transmitter portion is enabled when the enable/ disable input is logic high, and the signal receiver is enabled when the enable/disable input is low. When either transmitter or receiver portions are disabled by the corresponding enable/disable logic signal, the respective output connection assumes a high impedance characteristic, and there is no through transmission of the respective data signal. The 2-wire balanced input of the receiver and the 2-wire balanced output of the transmitter are parallel-wired to form a single 2-wire circuit comprising signals “A” and “B”, which are signal inverses, or complements, of one another. The enable/disable input thus controls whether the 2-wire A/B signal is an output, an input, or is in a high impedance state.

The three RS485 signals shown in FIG. 3(a) are assigned the functions T_{FPC}, T_{HDX}, and T_{FDX}. T_{FPC} is the synchronization signal as earlier described in accordance with FIGS. 1(a)-1(d). T_{FPC} is generated by the master interrogator, and is received by the slave interrogators. T_{HDX} is the adaptive timing control signal, which is generated by each of the slave interrogators and received by the master interrogator. T_{HDX} is a two-state signal indicative of the HDX transponder detection status of the slave interrogators. When T_{HDX} is at the first logic state indicative of no HDX transponder detection by any slave interrogator (and when the master interrogator is not detecting an HDX transponder), the master interrogator outputs a synchronization signal with a 3 msec OFF interval, in accordance with FIGS. 1(a) or 1(c). When T_{HDX} is at the second logic state indicative of an HDX transponder being detected by one or more slave interrogators, the master interrogator outputs a synchronization signal with a 20 msec OFF interval in accordance with FIGS. 1(b) or 1(d). More than one slave interrogator may simultaneously assert this second logic state, indicative of an HDX transponder being read by multiple readers.

The other signal T_{FDX} is the adaptive timing control signal, which is also generated in a like fashion by each of the slave interrogators, and received by the master interrogator. T_{FDX} is a two-state signal indicative of the FDX-B transponder detection status of the slave interrogators. When T_{FDX} is at the first logic state indicative of no FDX-B transponder detection by any slave interrogator (and when the master interrogator is not detecting an FDX-B transponder), the master interrogator outputs a synchronization signal with a 50 msec ON interval, in accordance with FIGS. 1(a) or 1(b). When T_{FDX} is at the second logic state indicative of an FDX-B transponder being detected by one or more slave interrogators, the master interrogator outputs a synchronization signalg with an ON interval of 50 to 100 msec, in accordance with FIGS. 1(c) or 1(d).

FIG. 3(b) shows the universal synchronization and adaptive timing circuit of FIG. 3(a) with active circuitry shown in bold to illustrate the configuration for the master interrogator. T_{FPC} is an output signal for the master interrogator, and consequently, the RS485 circuit's transmitter is enabled by a software configurable control signal “master/slave*” emanating from the interrogator's microcontroller. The 17.1776 MHz frequency is divided by 128 in order to derive the 134.2 kHz activation and synchronization signal, and the microcontroller's adaptive timing control output enables and disables this 134.2 kHz signal in accordance with the transponder detection states of the master interrogator and all slave interrogators, such that T_{FPC} assumes the timing characteristics of FIG. 1(a)-1(d), as is required. For the master interrogator, T_{HDX} and T_{FDX} are input signals, which are also software configurable as inputs by the microcontroller signals “HDX Detect Out” and “FDX-B Detect Out”.

FIG. 3(c) again shows the universal synchronization and adaptive timing circuit of FIG. 3(a) with active circuitry is shown in bold, this time to illustrate the configuration for a slave interrogator. T_{FPC} is an input signal for a slave interrogator, and consequently, the RS485 circuit's receiver is enabled by a software configurable control signal “master/ slave*” emanating from the slave interrogator's microcontroller. The microcontroller's adaptive timing control output disables the slave interrogator's internal 134.2 kHz signal, and enables the RS485 receiver in order to accept the master interrogator generated T_{FPC} signal, which is subsequently used by the slave as its activation signal source. For a slave interrogator, T_{HDX} and T_{FDX} are output signals, which are also software configurable as outputs by the microcontroller signals “HDX Detect Out” and “FDX-B Detect Out”. These two signals serve not only as detection status indicators, but also as the RS485 transmitter enable signals for each respective transmitter. Thus, when a slave interrogator is not detecting a transponder, the respective transmitter output assumes a high impedance characteristic, and when a transponder is detected, it asserts a logic high output.

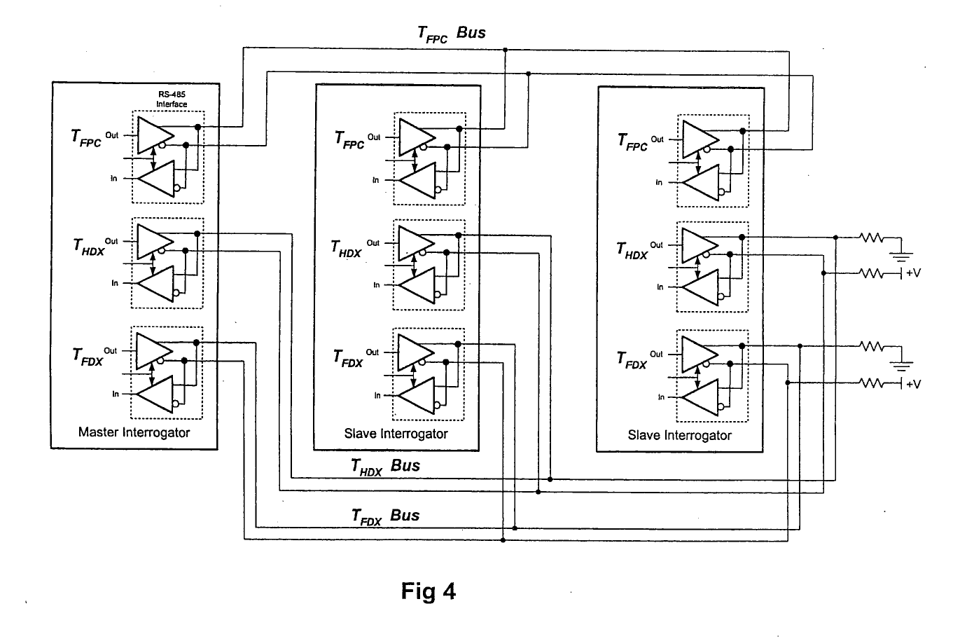

FIG. 4 illustrates the interconnection wiring of a synchronized and adaptively timed system comprising three interrogators (one master and two slaves). The master interrogator generates the synchronization signal T_{FPC} and distributes it via the RS485 bus to the two slave interrogator T_{FPC} inputs, which in turn use T_{FPC} to generate their synchronized and adaptively timed activation signals. In the absence of any transponder detection by either of the slave interrogators, the two adaptive timing control buses T_{HDX} and T_{FDX} are residing at logic low by virtue of high impedance biasing resistors, and all slave interrogator outputs T_{HDX} and T_{FDX} are high impedance. When a transponder is detected by any slave interrogator, it asserts a logic high on its respective T_{HDX} or T_{FDX} bus, thus signaling the master interrogator to adjust the timing as is appropriate in accordance with FIG. 1(a)-1(d).

The T_{HDX} and T_{FDX} signals which a slave interrogator outputs are thus either a high impedance state (no transponder detected) or an asserted logic high (transponder detected) state. The T_{HDX} and T_{FDX} bus states are maintained at a logic low condition by the biasing resistors. Consequently, the RS485 circuit configuration used for the T_{HDX} and T_{FDX} signals is a “wired-OR” logic function, and the T_{HDX} and T_{FDX} signal states seen by the master interrogator on its inputs is either logic low (no transponders detected) or logic high (at least one slave interrogator detecting a transponder).

In the manner described above, the invention provides a mechanism by which the frequency, phase, and cadence of interrogator activation signals can by synchronized while complying with the adaptive timing requirements of ISO Standard 11785.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A method of synchronizing a plurality of electronic identification interrogators comprising:
designating one of the plurality of interrogators as a master interrogator and designating at least one other interrogator as a slave interrogator;
sending a synchronization signal from the master interrogator;
receiving the synchronization signal in the slave interrogator;
activating the slave interrogator in accordance with the synchronization signal.

2. The method of claim 1 further comprising sending a status signal from the slave interrogator to the master interrogator.

3. The method of claim 2 wherein the status signal provides an indication of a transponder detection status of the slave interrogator.

4. The method of claim 2 further comprising the master interrogator adjusting the synchronization signal in response to the status signal and each slave interrogator activating accordingly, whereby the master interrogator and all of the slave interrogators operate synchronously.

5. The method of claim 1 further comprising the slave interrogator autonomously reconfiguring to become a master interrogator in response to a loss of the synchronization signal.

6. The method of claim 1 wherein the synchronization signal contains frequency information.

7. The method of claim 1 wherein the synchronization signal contains phase information.

8. The method of claim 1 wherein the synchronization signal contains timing information.

9. An electronic identification interrogation system comprising:
a master interrogator;
at least one slave interrogator;
a synchronization signal generator controlled by the master interrogator for sending a synchronization signal;
a receiver in the slave interrogator for receiving the synchronization signal;
an adaptive control circuit in the slave interrogator coupled to the receiver for activating the slave interrogator in accordance with the synchronization signal.

10. The electronic identification interrogation system of claim 9 wherein the synchronization signal is sent via a bidirectional data bus.

11. The electronic identification interrogation system of claim 10 wherein the data bus is a RS485 bus.

12. The electronic identification interrogation system of claim 9 wherein the synchronization signal is sent via an optical data interface.

13. The electronic identification interrogation system of claim 9 wherein the synchronization signal is sent via a wireless RF interface.

14. The electronic identification interrogation system of claim 9 wherein the synchronization signal is sent via a modem.

15. The electronic identification interrogation system of claim 9 wherein the slave interrogator includes circuitry to autonomously reconfigure the slave interrogator to become a master interrogator in response to a loss of the synchronization signal.

16. The electronic identification interrogation system of claim 9 wherein the synchronization signal contains frequency information.

17. The electronic identification interrogation system of claim 9 wherein the synchronization signal contains phase information.

18. The electronic identification interrogation system of claim 9 wherein the synchronization signal contains timing information.

19. The electronic identification interrogation system of claim 9 wherein the slave interrogator has at least two modes of operation and a status signal for each mode of operation is sent to the master interrogator on a separate data bus.

20. The electronic identification interrogation system of claim 9 wherein the slave interrogator has at least two modes of operation and a status signal for each mode of operation is sent to the master interrogator on a single shared data bus.

21. The electronic identification interrogation system of claim 9 wherein the slave interrogator includes circuitry for sending a status signal to the master interrogator.

22. The electronic identification interrogation system of claim 21 wherein the status signal provides an indication of transponder detection status.

23. The electronic identification interrogation system of claim 21 wherein the status signal is sent via a bidirectional data bus.

24. The electronic identification interrogation system of claim 23 wherein the data bus is a RS485 bus.

25. The electronic identification interrogation system of claim 21 wherein the status signal is sent via an optical data interface.

26. The electronic identification interrogation system of claim 21 wherein the status signal is sent via a wireless RF interface.

27. The electronic identification interrogation system of claim 21 wherein the status signal is sent via a modem.

28. A universal interrogator for an electronic identification interrogation system having one interrogator operating as a master interrogator and at least one slave interrogator, the universal interrogator comprising:
a synchronization signal generator;
a synchronization signal receiver;
a transponder status detector;
configuration control logic for configuring the universal interrogator as a master interrogator or a slave interrogator in response to an input from the synchronization signal receiver.
